(19) United States
(12) Patent Application Publication
(10) Pub. No.: US 2011/0195719 A1
(43) Pub. Date: Aug. 11, 2011

(54) Configuration of Nodes for Local Data Transmission Which are Under an Overlay Wide Area Macro Network Operated on the Same Frequency Layer

(76) Inventors: Mieszko Chmiel, Wroclaw (PL); Juergen Michel, Munich (DE); Maciej Niparko, Trzebnica (PL); Agnieszka Szufarska, Gdansk (PL)

(21) Appl. No.: 13/000,146

(22) PCT Filed: Jun. 20, 2008
(86) PCT No.: PCT/EP2008/057887

§ 371 Date: Apr. 25, 2011

(51) Int. Cl. H04W 72/04

(52) U.S. Cl. 455/450

(57) ABSTRACT

At a node for local data transmission which is under an overlay wide area macro network operated on the same frequency layer, conditions of a wide area cell of the overlay wide area macro network are obtained, wherein the wide area cell is measured as a cell with a certain received signal level at a location of the node. Based on the conditions of the wide area cell, an allocation of channels for local area data transmission from the node is set such that interference of the channels for the local area data transmission with allocated wide area channels of the wide area cell is avoided or minimized.

### FIELD OF THE INVENTION

The invention relates to mobile wireless communication systems, such as 3GPP Long-Term Evolution (LTE). In more detail, the invention relates to the configuration of small nodes for local data transmission, e.g. with local services and/or CSG (Closed Subscriber Group) applied, and which are under an overlay wide area macro network operated on the same frequency layer. For example, the invention relates to auto-configuration of small hotspots and low transmission power eNodeBs (eNBs) which are in the following called Home eNodeBs (HeNBs) and the case where this nodes area operated at the same frequency layer (same carrier frequency in the same frequency band) as NBs of the overlay wide area macro network.

### BACKGROUND OF THE INVENTION

It is typical for small nodes with local services and/or CSG applied, e.g. HeNBs, that they are low cost and in general deployed in indoor environment. In terms of radio network planning, the deployment is in most cases uncoordinated so the exact position where the small nodes, e.g. HeNBs, are located is not known to the operator.

HeNBs may support either any nearby UE (User Equipment) or only UEs belonging to a single closed subscriber group (CSG). Therefore HeNBs may be seen as additional interfering nodes with no possibility of handover for UEs not belonging to the supported CSG. This makes it reasonable to limit the HeNB transmission power to indoor coverage which is typically a transmission power smaller or equal to 20 dBm for the LTE with 5, 10 MHz and 20 MHz bandwidth.

The HeNB should be able to use a range of frequency bands according to needs of an operator, and a relevant scenario for radio investigations there is that the frequency band of operation should be different from the frequency band used by the macro layer. This approach has one major disadvantage that is the need for the operator to have an additional band/frequency carrier for HeNB operation.

Therefore, it has been studied under what conditions co-existence of an eNB and an HeNB in the same geographical area and frequency carrier is possible (which is called the co-channel case), and what mechanisms are needed or may be useful to mitigate the problem in downlink that the wide area coverage is influenced due to interference from HeNBs in co-channel deployments with CSG (wide area (WA) coverage holes).

One solution is a partial co-channel deployment where e.g. in a 10 MHz bandwidth two 5 MHz LTE carriers are operated as follows: in carrier 1 a mixture of wide area NBs and local area HeNBs is deployed whereas in carrier 2 only wide area NBs are deployed. Therefore, if HeNB downlink interference disturbs a wide area user and the wide area user is not a member of the HeNB CSG a handover to carrier 2 is initiated. The disadvantage of this solution is that with splitting the MHz LTE system in two 5 MHz systems the scheduling diversity, the spectrum efficiency and the maximum achievable peak data rate is reduced.

A further solution for the co-channel case is to reduce the downlink interference originated from HeNB by controlling or setting the HeNB downlink power according to the path-loss to the strongest WA cell. The disadvantage of controlling the HeNB power based on the path-loss or distance to the strongest WA cell is that it mitigates but does not solve the problem of downlink control channel collisions.

### SUMMARY OF THE INVENTION

Embodiments of the invention aim at solving the above problems and provide an apparatus and a method for minimizing or eliminating downlink channel collisions probability.

According to an aspect of the invention, an apparatus is provided, comprising:
a receiver configured to obtain conditions of a wide area cell of an overlay wide area macro network operated on the same frequency layer as the apparatus, wherein the wide area cell is measured as a cell with a certain received signal level at a location of the apparatus; and
a processor configured to set an allocation of channels for local area data transmission from the apparatus based on the conditions of the wide area cell such that interference of the channels for the local area data transmission with allocated wide area channels of the wide area cell is avoided.

According to a further aspect of the invention, a method is provided, comprising:
obtaining conditions of a wide area cell of an overlay wide area macro network operated on the same frequency layer as an apparatus for local data transmission, wherein the wide area cell is measured as a cell with a certain received signal level at a location of the apparatus; and
setting an allocation of channels for the local area data transmission from the apparatus based on the conditions of the wide area cell such that interference of the channels for the local area data transmission with allocated wide area channels of the wide area cell is avoided.

Data transmitted in the local area data transmission may comprise control data, control information and control signals.

The receiver may comprise a user equipment which may receive signals from the overlay wide area macro network and measures the wide area cell as the cell with the certain received signal level which is the highest signal level received by the user equipment from the overlay wide area macro network, and may measure the conditions of the wide area cell.

The conditions of the wide area cell may comprise wide area resources over which channels of the wide area cell are transmitted, wherein the use of the wide area resources for the allocation of channels for the local area data transmission from the apparatus may be prohibited.

The conditions of the wide area cell may comprise wide area resources over which channels of the wide area cell are transmitted, wherein use of resources for the allocation of channels for the local area data transmission from the apparatus other than the wide area resources may be prioritized. Moreover, transmission power for the local area data transmission from the apparatus may be reduced in case resources colliding with the wide area resources are used for the local area data transmission from the apparatus. The channels of the wide area cell may comprise at least one of a physical downlink shared channel, a physical broadcast channel and a physical synchronization channel.

Alternatively or in addition, the conditions of the wide area cell may comprise timing information on a transmission time of channels of the wide area cell, wherein a time shift of the allocation of channels for the local area data transmission from the apparatus may be set based on the timing information such that the allocation of channels for the local data transmission is different in timing from that of the channels of the wide area cell. The channels for the local data transmission and the channels of the wide area cell may comprise at least one of a physical broadcast channel, a synchronization channel, reference symbols and a physical downlink control channel.

An identity of the wide area cell and the time shift set may be communicated to a network element, and the time shift may be altered based on a response from the network element.

Furthermore, the time shift may be set based on timing information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in timing from that of the channels of the wide area cell and the at least one of the further wide area cells and the cells for local area data transmission.

Alternatively, the time shift may be set based on timing information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in timing from that of the channels of the wide area cell and is different in timing from that of the at least one of the further wide area cells and the cells for local area data transmission with priority in order to the received signal levels of the at least one of the further wide area cells and the cells for local area data transmission.

Alternatively or in addition, the conditions of the wide area cell may comprise the identity of the wide area cell and frequency information on a transmission frequency of channels of the wide area cell, wherein a local area cell identity for achieving a frequency shift of the allocation of channels for the data transmission from the apparatus different from the identity of the wide area cell and based on the frequency information may be calculated such that the allocation of channels for the local data transmission is different in frequency from that of the channels of the wide area cell. The channels for the local data transmission and the channels of the wide area cell may comprise at least one of a physical control format indicator channel, a physical hybrid ARQ indicator channel and reference symbols.

The frequency information may comprise a frequency shift implied by the identity of the wide area cell. According to an embodiment of the invention, “different in frequency” means use of different OFDM resource elements in terms of frequency for the same point of time.

The local area cell identity may be calculated by taking further into account the time shift set.

The identity of the wide area cell and the local area cell identity calculated may be communicated to the network element, and the local area cell identity may be altered based on a response from the network element.

In addition, the time shift set may be communicated to the network element.

Furthermore, the local area cell identity may be calculated based on an identity and frequency information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in frequency from that of the channels of the wide area cell and the at least one of the further wide area cells and the cells for local area data transmission. The local area cell identity may be calculated further based on the time shift set.

Alternatively, the local area cell identity may be calculated based on an identity and frequency information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in frequency from that of the channels of the wide area cell and is different in timing from that of the at least one of the further wide area cells and the cells for local area data transmission with priority in order to the received signal levels of the at least one of the further wide area cells and the cells for local area data transmission. The local area cell identity may be calculated further based on the time shift set.

The frequency information may comprise a frequency shift implied by the identities of the wide area cells and cells for local area data transmission.

The receiver may obtain measurements from a plurality of user equipments receiving signals from the overlay wide area macro network, each user equipment of the plurality of user equipments measuring a particular wide area cell as a cell with the highest signal level received by the user equipment from the overlay wide area macro network, and measuring the conditions of the particular wide area cell. The cell with the highest overall received signal level from the particular wide area cells may be selected as the wide area cell.

Furthermore, at least one further cell may be selected from the particular wide area cells with priority in order to their received signal levels, and the allocation of channels for the local area data transmission from the apparatus may be set based on the conditions of the wide area cell and the at least one further cell such that interference of the channels for the local area data transmission with allocated wide area channels of the wide area cell and the at least one further cell is avoided.

The invention may also be implemented by a computer program product.

According to an embodiment of the invention, at a node for local data transmission which is under an overlay wide area macro network operated on the same frequency layer, conditions of a wide area cell of the overlay wide area macro network are obtained, wherein the wide area cell is measured as a cell with a certain received signal level at a location of the node. Based on the conditions of the wide area cell, an allocation of channels for local area data transmission from the node is set such that interference of the channels for the local area data transmission with allocated wide area channels of the wide area cell is avoided or minimized.

According to an embodiment of the invention, data transmitted in the local area data transmission may comprise control data, control information and control signals.

According to embodiments of the invention, collision probability with wide area (WA) control channels can be reduced or eliminated by coordination of channel allocation in small nodes for local data transmission.

For the purpose of the embodiments of the present invention to be described herein below, it should be noted that
a user equipment may for example be any device by means of which a user may access a communication network; this implies mobile as well as non-mobile devices and networks, independent of the technology platform on which they are based; only as an example, it is noted that terminals operated according to principles standardized by the 3^{rd} Generation Partnership Project 3GPP and known for example as LTE terminals are particularly suitable for being used in connection with the present invention;
method steps likely to be implemented as software code portions and being run using a processor at a node are software code independent and can be specified using any known or future developed programming language;
method steps and/or devices likely to be implemented as hardware components at a node are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices can be implemented as individual devices, but this does not exclude that they are implemented in a distributed fashion throughout the system, as long as the functionality of the device is preserved.

### BRIEF DESCRIPTION OF THE DRAWINGS

FIG. 1 shows a schematic diagram illustrating an arrangement of a small node under an overlay wide area macro network according to an embodiment of the invention.

FIG. 2 shows a schematic diagram illustrating channels transmitted in central 72 subcarriers and their time allocations.

FIG. 3 shows a schematic diagram illustrating frequency resources used by PCFICH/PHICH.

FIG. 4 shows a schematic diagram illustrating mapping of downlink reference symbols for different antenna configurations and normal cyclic prefix.

### DESCRIPTION OF THE INVENTION

In the following the invention will be described by way of embodiments thereof with reference to the accompanying drawings.

In the following, embodiments of the invention which minimize or eliminate wide area and local area collision probability are described. If wide area (WA) and local area (LA) networks are deployed in the same frequency band (co-channel deployment) interference experienced by WA UEs coming from the LA HeNB is significantly higher than in adjacent-channel deployments and collisions result in significant performance degradation, especially in dense urban areas with dense HeNB deployment.

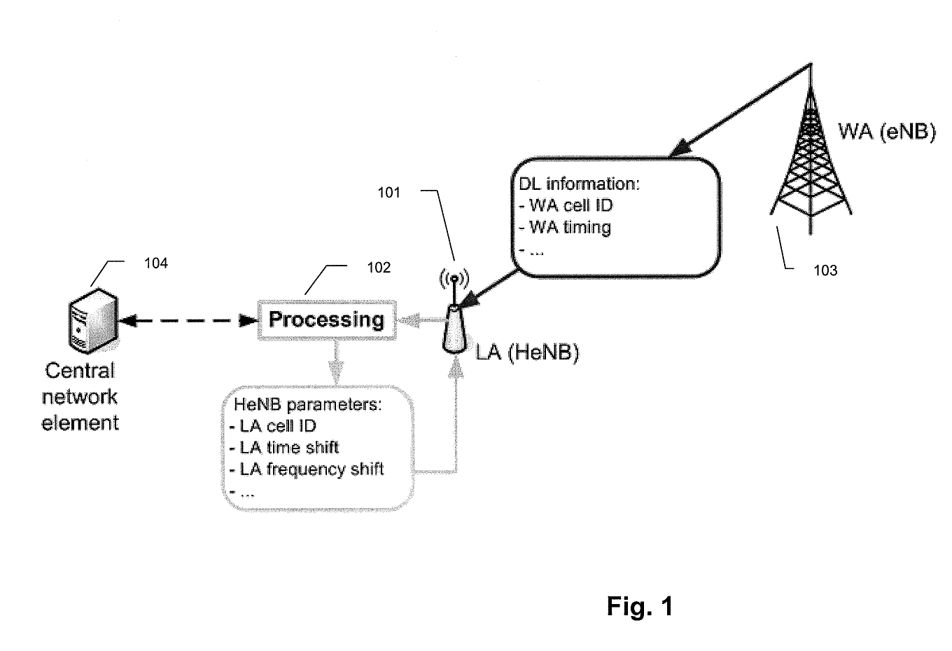

FIG. 1 shows a schematic diagram illustrating an arrangement of a small node under an overlay wide area macro network (WA network) according to an embodiment of the invention. The small node may be an LA HeNB. A UE-type receiver 101 may be camped or connected to the LA HeNB, or may be integrated with the LA HeNB. The receiver 101 receives information from a node 103 of the overlay wide area macro network, such as a WA eNB. The LA HeNB comprises a processor 102 for performing processing based on the information obtained from the receiver 101. The processor 102 may communicate with a network element 104, such as a central network element. The information obtained from the WA eNB 103 may comprise conditions of a wide area (WA) cell the WA eNB 103 is responsible for. The conditions may comprise resources for wide area channels, an identity of the WA cell (WA cell ID), a WA timing and frequency information on a transmission frequency of channels of the wide area cell. The processor 102 sets an allocation of channels for local area data and control information transmission from the LA HeNB based on the conditions of the wide area cell. In this respect the processor determines LA HeNB parameters which may comprise an identity of a local area cell the LA HeNB is responsible for, an LA time shift and an LA frequency shift, which will be described in the following.

The following embodiments of the invention are applicable to control and data channels of LA HeNBs and can be adopted alone or in combination.

A) Scheduling restrictions for LA HeNBs

According to this embodiment of the invention, scheduling restrictions are applied for time and frequency resources related to HeNB data (shared) channels in downlink. This may be coordinated by means of measurement-assisted scheduling. For example, a restriction may be that LA HeNBs are not allowed to schedule users in downlink on frequency chunks used for P-SCH (Primary Synchronization Channel), S-SCH (Secondary Synchronization Channel), BCH (Broadcast Channel) of the WA cell in order to avoid collision of LA HeNB downlink PDSCH (Physical Downlink Shared Channel) with these control channels in the WA cell.

A procedure for scheduling restrictions for LA HeNBs may comprise the following:

(1) The receiver 101, e.g. a UE receiver which is either camped/connected to the LA HeNB shown in FIG. 1 or integrated with the LA HeNB, listens and identifies a strongest WA cell, i.e. a WA cell with the highest received signal level (in FIG. 1 the WA cell the WA eNB 103 is responsible for):
(a) The receiver 101 identifies resources over which a certain wide area control channel (e.g. PBCH (Physical Broadcast Channel)) is transmitted from the WA eNB 103 in frequency. The resources may be identified also in time.
(b) The receiver 101 identifies resources over which only WA PDSCH can be transmitted (partial co-channel case).
(2) The processor 102 sets an allocation of channels such that the LA HeNB is disallowed to use resources identified in (1).

According to another embodiment, the LA HeNB is disallowed to use LTE center frequency chunks in which a synchronization and broadcast channel are transmitted for PDSCH as a rule in specification.

According to still another embodiment, not a strict prohibition to use resources by the LA HeNB which interfere with WA control channel(s) is adopted, but the resources are prioritized in a manner that, first, non-interfering resources are used, before the interfering ones are used by the LA HeNB. Collisions will then only occur in high-load cases in the LA HeNB. Additionally, power restriction on critical resources (i.e. interfering resources) may be applied in order to trade-off performance loss in the HeNB and impact on the WA network.

### B) Cell-Specific Time Shift

According to this embodiment of the invention, a fixed time shift is applied for signals/channels from LA HeNB nodes to UEs. In principle this de-synchronizes LA HeNB cells from the strongest WA cell(s). For example, if LA HeNBs are not transmitting their downlink reference signals and/or their downlink synchronization signals and the physical broadcast channel at the same time as the strongest WA cell measured at the LA HeNBs, it is ensured that the broadcast channel and synchronization channel of the WA cells is not drowned by the broadcast channel or synchronization channels of the LA HeNBs.

As LA HeNB data transmission might still cause collisions, it may be beneficial to combine B) with other possibilities, e.g. the scheduling restrictions described above in A).

A procedure for performing cell-specific time shift may comprise the following:

(1) The receiver 101, e.g. a UE receiver which is either camped/connected to the LA HeNB shown in FIG. 1 or integrated with the LA HeNB, listens and identifies a strongest WA cell, i.e. a WA cell with the highest received signal level (in FIG. 1 the WA cell the WA eNB 103 is responsible for):
(a) The receiver 101 identifies synchronization or timing information for the strongest WA cell, i.e. information at what time broadcast and synchronization channels are transmitted from the WA eNB 103, i.e. 10 ms radio frame timing or 5 ms timing.
(2) The processor 102 determines a fixed time shift assuring that control channels (PBCH and/or SCH and/or RS (Reference Symbols) and/or PDCCH (Physical Downlink Control Channel), etc.) are not transmitted at the same time by the LA HeNB and by the strongest WA cell, i.e. the WA eNB 103.
(3) The processor 102 of the LA HeNB performs de-synchronization with a fixed timing value autonomously, or
(4) optionally reports to a network element 104, e.g. an O&M (Operations and Maintenance) center or femto gateway, the strongest measured WA cell (e.g. a physical cell ID) and the used (selected) timing value for time shift, and then waits for an acknowledgement (ACK) from the network element 104. However, if the network element 104 does not approve the proposed value and there is no acknowledgement (NACK) indicated from the network element 104 to the processor 102 of the LA HeNB, the processor 102 of the LA HeNB may suggest a new and different value or the network element 104 may signal an appropriate value for the time shift to the processor 102.

If the processor 102 detects several possible time shifts based on the above procedure, optionally the processor 102 selects a final time shift based on achieving de-alignment with further WA and/or HeNB cells with priority in order to their received signal strengths measured by the receiver 101.

### C) Cell-Specific Frequency Shift

Cell-specific frequency allocation is already used for some channels (PHICH (Physical Hybrid ARQ Indicator Channel), PCFICH (Physical Control Format Indicator Channel), reference symbols (RS)). According to this embodiment, cell-specific frequency shift is used in order to avoid collisions between the LA HeNB and the ‘umbrella’ WA eNB. A cell-specific frequency shift is based on Cell ID and it should be ensured that the LA HeNB has a different cell ID resulting in a different frequency shift than the one used by the ‘umbrella’ macro cell and to be more specific by the strongest received WA macro cell measured at the LA HeNB or reported by UEs connected to the LA HeNB. For example this supports reducing collisions between the LA HeNB's and the WA eNB's PCFICH and PHICH in the downlink.

A procedure for performing cell-specific frequency shift may comprise the following:

(1) The receiver 101, e.g. a UE receiver which is either camped/connected to the LA HeNB shown in FIG. 1 or integrated with the LA HeNB, listens and identifies a strongest WA cell, i.e. a WA cell with the highest received signal level (in FIG. 1 the WA cell the WA eNB 103 is responsible for):
(a) The receiver 101 identifies a cell ID of the strongest WA cell and a frequency shift implied by the cell ID for certain channels transmitted by the strongest WA cell.
(2) The processor 102 of the LA HeNB autonomously selects the cell ID of the LA HeNB:
(a) It should be assured that not only the LA HeNB's cell ID is different from the strongest WA eNB's cell ID but also both these IDs give a different PHICH/PCFICH allocation in frequency in the LA HeNB and the WA eNB 103, or more generally different allocation in the frequency domain of certain channels.
(b) In the selection of the LA HeNB's cell ID, the cell specific time shift has to be considered. Therefore, if B) and C) are performed in combination, B) should be performed before C).
3. With the cell ID of the LA HeNB selected as described above, the LA HeNB and the overlaying WA eNB 103 transmit PHICH/PCFICH over different frequency resources.
4. Optionally, instead of autonomously selecting the cell ID of the LA HeNB, the processor 102 of the LA HeNB reports to the network element 104 the strongest measured WA cell (e.g. physical cell ID) and the current cell ID of the LA HeNB, and then waits for an acknowledgement (ACK) from the network element 104. However, if the network element 104 does not approve the proposed cell ID value and there is no acknowledgement (NACK) indicated from the network element 104 to the processor 102 of the LA HeNB, the processor 102 may suggest a new and different value or the network element 104 may signal an appropriate value to the processor 102.

In case UE receivers camping or connected to the LA HeNB are used, additional triggers to receive the corresponding measurements of the WA cell are necessary. In case many UE receivers are camping or connected to the LA HeNB, a decision making process is performed which may comprise either a selection of one measurement report from one of the UE receivers, or a decision based on all measurement reports from all of the UE receivers. According to an embodiment, in order to minimize the impact on the WA network, coordination with the WA cell with highest overall received signal level is preferred. Alternatively, a joint optimization of the shift considering the N strongest reported cells, or a two-step approach may be performed in which first possible frequency shifts are selected based on the strongest WA cell, and then further selection is performed based on further WA or/and HeNB cells with priority in order to their received signal strengths.

It is to be noted that coordination with the WA cell with highest overall received signal level, joint optimisation or the two-step approach is applicable also in embodiments A) and B).

In the following implementation examples of the above described embodiments are given for each of the LA HeNB channels, and it is described how collision probability with WA control channels can be reduced or eliminated by coordination. The embodiments and implementation thereof avoid or minimize the cases where WA downlink control channels are drowned by LA (HeNB) downlink control and data channels in the co-channel deployment case.

1) LA (HeNB) Physical Downlink Shared Channel (PDSCH) Allocation to Avoid that WA Control Channels are Drowned by LA HeNB PDSCH

A PDSCH is a shared downlink channel for data transmission. Resources are shared by different users in both time and frequency, resource allocation is based on CQI (Channel Quality Indicator) measurements and set by a DL scheduling grant (PDCCH).

Time and frequency resources of the PDSCH are not fixed and are allocated by means of scheduling which may be performed by the processor 102.

In order to prevent collisions, the processor 102 of the LA HeNB has to take care that no LA HeNB PDSCH is scheduled over a WA PBCH. The processor 102 of the LA HeNB acting as scheduler has to be aware of resources used for WA PBCH/SCH and avoid allocating these resources. The processor 102 detects these resources and avoids allocating these resources as described in embodiment A) above.

According to an embodiment, the LA HeNB is fully disallowed to use the LTE center frequency chunks, i.e. 72 central subcarriers, where synchronization and broadcast channel is transmitted for WA PDSCH transmission.

2) LA (HeNB) Physical Broadcast Channel (PBCH) and Allocation to Avoid that WA Control Channels are Drowned by LA HeNB PBCH

A PBCH is a channel for broadcasting system information, e.g. DL bandwidth, PHICH configuration, System Frame Number.

Time resources of the PBCH are fixed, i.e. always the first 4 OFDM (Orthogonal Frequency Division Multiplexing) symbols in the second slot of a sub-frame. A PBCH burst is transmitted every 10 ms with a 40 ms TTI (Transmission Time Interval).

The frequency resources of the PBCH are fixed, i.e. the central 72 sub-carriers. Inter-cell interference is mitigated by a very low coding rate and cell-specific scrambling.

In order to prevent collisions, coordination in time is applied as described in embodiment B) of cell-specific time shift. The LA HeNB cell (the LA cell the LA HeNB is responsible for) has to be de-synchronized with the ‘umbrella’ WA macro cell (the WA cell the WA eNB is responsible for). After obtaining synchronization, i.e. after acquiring the DL RX timing of the WA eNB, the processor 102 of the LA HeNB autonomously selects a specific time shift that is used to desynchronize from the overlaying WA cell. The PBCH is transmitted in central 72 sub-carriers, which are also used for SCH in different slots. When selecting the time shift applied for an LA HeNB PBCH, the processor 102 should take into account not only a WA PBCH, but also a WA SCH location in a radio frame.

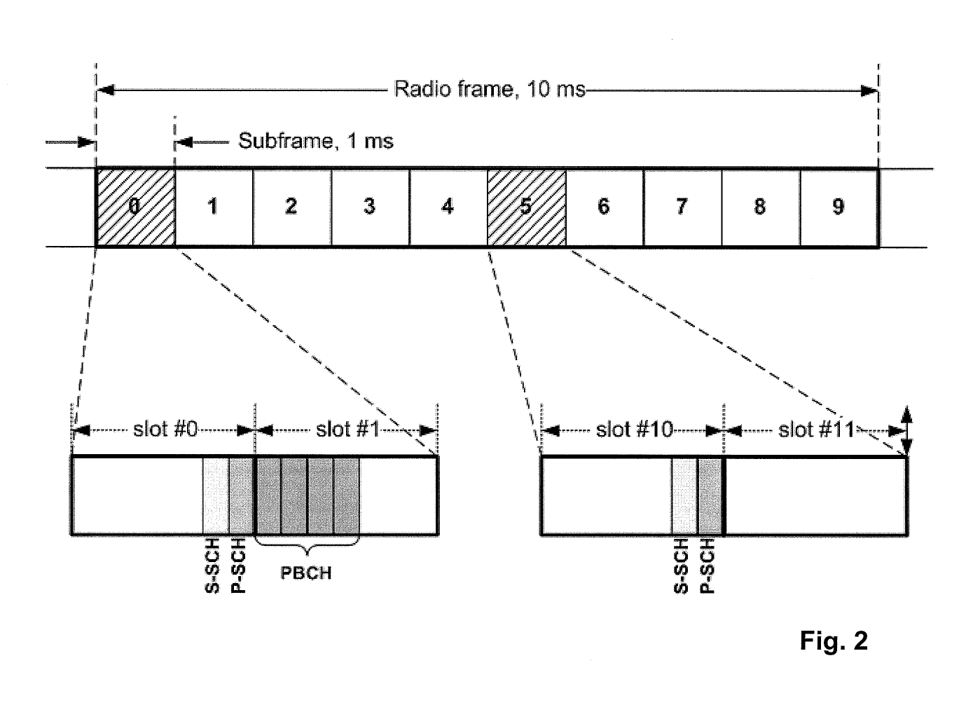

As shown in FIG. 2, a radio frame of 10 ms comprises 10 sub-frames of 1 ms, each sub-frame comprising two slots. In slot #0 of sub-frame #0 and in slot #10 of sub-frame #5 P-SCH (Primary Synchronization Channel) and S-SCH (Secondary Synchronization Channel) are transmitted. In slot #1 (second time slot) of sub-frame #0 PBCH is transmitted.

Thus, assuming that the time allocations shown in FIG. 2 are those of the strongest WA cell, the LA HeNB could transmit PBCH with {1, 2, 3, 4, 6, 7, 8, 9} sub-frame(s) delayed/advanced after/before PBCH received sub-frame timing from the strongest WA cell. When selecting time shifts available for the LA HeNB, the processor 102 should also take into account possible collisions on other channels: PDCCH is located in the first (1 to 3) OFDM symbols of each slot. A time delay/advance of {3, 5, 7, 9, 11, 13, 15, 17, 19} slots can also avoid the HeNB's PDCCH/PHICH/PCFICH to collide with the WA eNB's PDCCH/PHICH/PCFICH. It is to be noted that shifts by an even number of slots are equivalent to shifts by a sub-frame as described above, as two slots give a sub-frame. Obviously also shifts of a fraction of a slot are possible as well, since PBCH, S-SCH and P-SCH only cover part of a slot.

Alternative and/or additional time shifts may also take into account collisions with further WA and/or HeNB cells with priority according to received signal strengths as described above.

3) LA (HeNB) Broadcast Control Channel Over PDSCH (BCCH Over DL-SCH Over PDSCH) and Allocation to Avoid that WA Control Channels are Drowned by LA HeNB BCCH

A BCCH is a channel for broadcasting system information, e.g. RACH (Random Access Channel) parameters, UL (UpLink) configuration etc.

Time resources of the BCCH are specific sub-frames dynamically scheduled (but TTIs of scheduling units will be fixed, e.g. SI-1: 80 ms, SI-2: 160 ms etc.). Frequency resources of the BCCH are dynamically scheduled, but with limited flexibility.

In order to prevent collisions, the processor 102 of the LA HeNB should take care that no LA BCCH is scheduled over WA PBCH and SCH regions. The processor 102 acting as LA HeNB scheduler detects resources used for WA PBCH/SCH and avoids allocating these resources according embodiment A). According to an embodiment, the LA HeNB is fully disallowed to use the LTE center frequency chunks for a LA BCCH where synchronization and broadcast channel is transmitted for a WA BCCH.

According to an embodiment, the mechanisms of applying a time shift as described above may be used as well, i.e. the LA BCCH is transmitted with proper de-alignment from the WA PBCH and SCH regions.

4) LA (HeNB) Physical Downlink Control Channel (PDCCH) and Allocation to Avoid that WA Control Channels are Drowned by HeNB PDCCH

The physical downlink control channel carries scheduling assignments and other control information, e.g. DL Resource allocation, UL Grants, paging, RACH response, BCCH allocation, etc.

Time resources of the PDCCH are fixed, i.e. the first 1-3 symbols of each subframe; also 4 symbols can be used for small system bandwidths. The number of symbols used for the PDCCH is given by PCFICH information and is determined by the number of UEs and coverage requirements. The LA HeNB may use one symbol due to low coverage controlling load requirements.

Frequency resources of the PDCCH are fixed, spread over full bandwidth, with interleaving and cell-specific frequency shifting.

Even in case of collisions, due to low coding rate, frequency diversity and cell-specific scrambling UEs should be able to receive the PDCCH.

In order to prevent collisions a time shift as described in implementation example 2) above may be applied for assuring that even in case of PDCCH collisions between the LA HeNB and the ‘umbrella’ WA macro cell all control information are decoded properly.

Furthermore it may be beneficial to cancel the interference from the HeNB PDCCH as much as possible, e.g. by using as many CCEs (Control Channel Elements) as possible. Due to small numbers of users attached and good channel conditions, it may be possible to use only few CCEs to convey scheduling information, however it may be better to use more CCEs and code the message with more coding gain but lower power instead. This gives a more even distribution of the interference to all subcarriers.

5) LA (HeNB) Physical Control Format Indicator Channel (PCFICH) and Allocation to Avoid that WA Control Channels are Drowned by HeNB PCFICH

A PCFICH indicates how many OFDM symbols (1 to 3) are used for PDCCH(s).

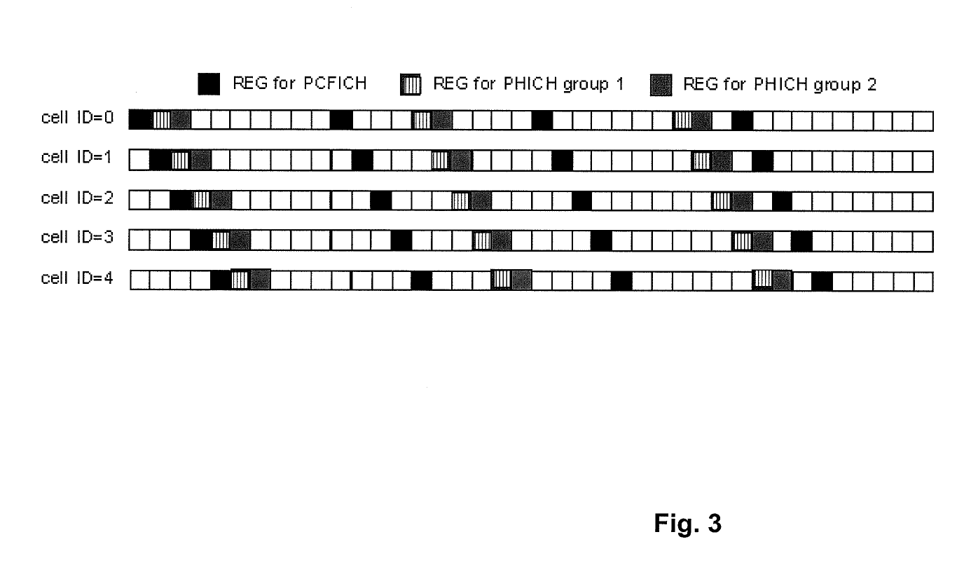

Time resources of the PCFICH are fixed and transmitted in the first symbol of each subframe. Frequency resources of the PCFICH are ID-dependent. PCFICH mapping depending on a cell ID is done as shown in FIG. 3 so that randomization or avoidance of PCFICH resource collision is possible depending on a cell planning. FIG. 3 shows frequency resources used by PCFICH/PHICH.

The number of resources is fixed, there are 16 subcarriers in 4 REGs (Resource Element Groups).

In order to prevent collisions, coordination is applied as described in embodiment C). With no coordination, the LA HeNB might have a cell ID that gives same PCFICH mapping as is used for the ‘umbrella’ WA cell (strongest received WA cell) resulting in collisions on PCFICHs. The processor 102 of the LA HeNB obtains a WA cell ID from measurements and chooses a cell ID that is mapped onto different frequency shift over PCFICH as described in embodiment C).

In general, the selection of the HeNB cell ID follows the adopted solution for automated physical cell ID planning. However, the coordination with the WA cell puts an additional restriction on the selected cell ID of the LA HeNB.

The PCFICH mapping to resource elements is defined in terms of quadruplets of complex-valued symbols. Let z^{(p)} (i) denote symbol quadruplet i for antenna port p. For each of the antenna ports, symbol quadruplets shall be mapped in increasing order of i to the four resource-element groups in the first OFDM symbol in a downlink subframe by

z^{(p)}(0) is mapped to the resource-element group represented by k= k̅
z^{(p)}(1) is mapped to the resource-element group represented by k=k+ k̅+└N_{RB}^{DL}/2┘·N_{sc}^{RB}/2
z^{(p)}(2) is mapped to the resource-element group represented by k= k̅+└2N_{RB}^{DL}/2┘·N_{sc}^{RB}/2
z^{(p)}(3) is mapped to the resource-element group represented by k= k̅+└3N_{RB}^{DL}/2┘·N_{sc}^{RB}/2
where the additions are modulo N_{RB}^{DL}N_{sc}^{RB},

k̅=(N_{sc}^{RB}/2)·(N_{ID}^{cell} mod 2N_{RB}^{DL})

and N_{ID}^{cell} is the physical-layer cell identity.

If the above N_{ID}^{cell} is the physical (PHY) cell ID of the WA eNB, in order to avoid collisions with the cell ID of the WA eNB, the cell ID of the HeNB can be determined as follows: N_{ID}^{cell}^{_{—}}^{HeN}=(N_{ID}^{cell}+offset)mod 504, where the offset can take any (random) value from the range:

$$offset ∈ \{ 1 , 2 , … , \frac{{N}_{RB}^{DL}}{2} - 1 \} .$$

where N_{ID}^{cell} is the PHY cell ID of the WA eNB.
6) LA (HeNB) Physical Hybrid ARQ Indicator Channel (PHICH) and Allocation to Avoid that WA Control Channels are Drowned by HeNB PHICH

A PHICH carries the hybrid-ARQ ACK/NAK (hybrid Admission ReQuest ACKnowledgment/Negative AcKnowledgement).

Time resources of the PHICH are fixed, i.e. always transmitted in the first symbol of each subframe, and in overall 3 REGs are transmitted per symbol. If coverage requirements are high, only one PHICH group is transmitted in the first 3 OFDM symbols, i.e. one REG per symbol.

Frequency resources of the PHICH are ID-dependent. PHICH mapping depends on the cell ID as shown in FIG. 3 so that randomization or avoidance of PHICH resource collision is possible depending on the cell planning.

There is a fixed number of resources, i.e. 12 subcarriers per one PHICH group in 3 REGs, in which one group is used for ACK/NACK transmission for up to 8 UEs.

In order to prevent collisions, similar cell ID selection method as described above for PCFICH is adopted which minimizes the PHICH collisions.

7) LA (HeNB) Downlink Reference Symbols and Allocation to Avoid that WA Control Channels are Drowned by HeNB Downlink Reference Symbols

Reference symbols (RS) are used for channel estimation (replacing WCDMA (Wideband Code Division Multiple Access) CPICH (Common Pilot Channel)), CQI measurements, mobility measurements and cell search/acquisition.

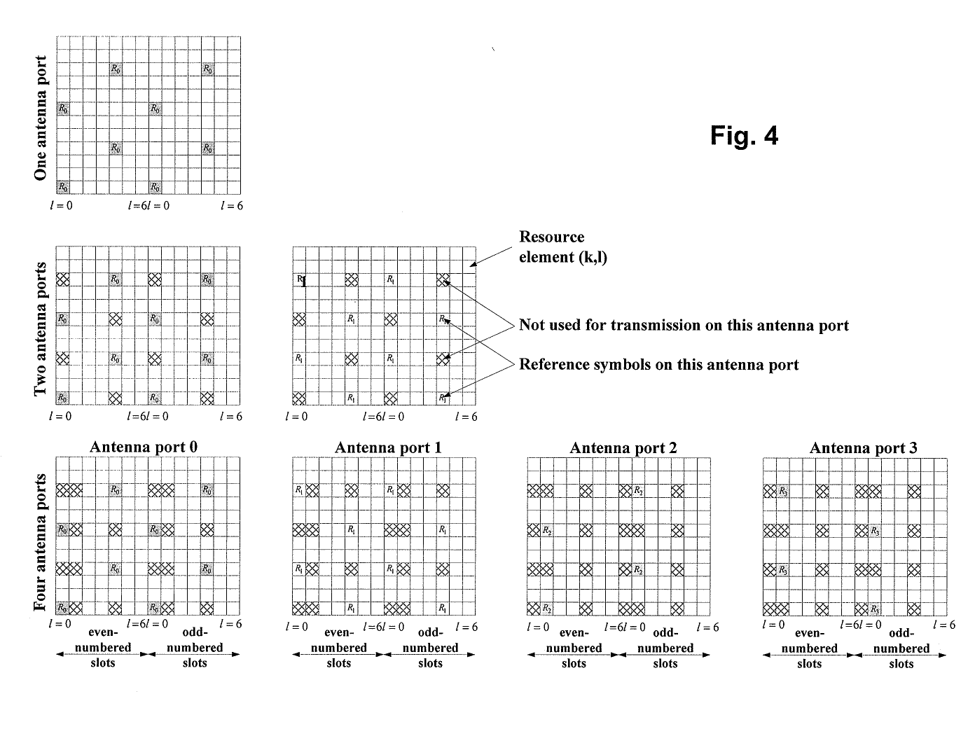

Time resources of the reference symbols are fixed. The reference symbols are transmitted at OFDM symbols 0 and 4 of each slot (in one and two TX antenna case) or symbols 0, 1 and 4 of each slot (in four TX antenna case). The exact location of the reference symbols depends on the antenna port number. FIG. 4 shows mapping of DL reference symbols with normal cyclic prefix for one, two and four TX antenna cases.

Frequency resources of the reference symbols are fixed. For different antenna configurations different combinations of resource allocations are used. A reference symbols from one antenna is located in every 6^{th} subcarrier over the whole frequency band. A cell-specific frequency shift is applied.

RS are spread over the whole frequency band, and should not collide between LA cell and its strongest received WA cell. According to an embodiment, coordination is performed in time domain:

The LA HeNB may have up to 2 TX antennas. Thus, even for 4 TX antennas at the WA eNB it is possible to perform coordination by using a cell-specific time shift according to embodiment B). For example, a time shift of ±{1,2} OFDM symbols from the RX WA eNB's sub-frame timing avoids RS-to-RS collisions.

According to another embodiment, coordination is performed in frequency domain:

In this case a different frequency shift is added to DL RS of the LA HeNB. The procedure is similar to that described for PCFICH/PHICH according to embodiment C). For example, the following determination of the LA HeNB's cell ID can be used to avoid RS collisions by an orthogonal frequency cell specific frequency shift:
Let N_{ID}^{cell} be the cell ID of the WA eNB, then the frequency shift of this cell is given by f_{shift}_{_{—}}_{WA}=(N_{ID}^{cell})mod 6. However, for the case of 2 and 4 TX antennas there are only 3 orthogonal frequency domain shifts contrary to the 1 TX antenna case with 6 shifts. The cell ID of the LA HeNB is selected such that:
for 1TX: (N_{ID}^{cell}^{_{—}}^{HeN})mod 6=(N_{ID}^{cell})mod 6+X where Xε{1,2,3,4,5}, therefore, N_{ID}^{cell}^{_{—}}^{HeN}=N_{ID}^{cell}+Z+X)mod 504 where Z can be any (random) number from {0,6,12, . . . ,498}
for 2TX or 4 TX: (N_{ID}^{cell}^{_{—}}^{HeN})mod 3=(N_{ID}^{cell})mod 3+X where Xε{1,2}, therefore, N_{ID}^{cell}^{_{—}}^{HeN}=N_{ID}^{cell}+Z+X)mod 504 where Z can be any (random) number from {0,3,6,9, . . . ,501}
   8) LA (HeNB) Downlink Synchronization Channel (SCH) and Allocation to Avoid that WA control Channels are Drowned by HeNB Downlink Reference Symbols

Synchronization signals of a SCH can indicate 504 (168×3) different values and from those the location of cell specific reference symbols and one of 504 cell IDs can be determined.

Time resources of the SCH are fixed and located in the last and second last OFDM symbols (primary and secondary respectively) of slot # 0 and #10 in each radio frame.

Frequency resources of the SCH are fixed. Synchronization signals are allocated in 72 sub-carriers in the middle of the downlink bandwidth to facilitate UE cell search.

In order to prevent collisions, the processor 102 of the LA HeNB uses the same mechanism for PBCH and SCH collision prevention. In other words, allocation to avoid that WA control channels are drowned by LA HeNB SCH is performed according to embodiment B) similarly as described above in “2) LA (HeNB) Physical broadcast channel (PBCH) and allocation to avoid that WA control channels are drowned by LA HeNB PBCH” for the LA (HeNB) PBCH.

It is to be understood that the above description is illustrative of the invention and is not to be construed as limiting the invention. Various modifications and applications may occur to those skilled in the art without departing from the true spirit and scope of the invention as defined by the appended claims.

1. An apparatus, comprising: a receiver configured to obtain conditions of a wide area cell of an overlay wide area macro network operated on the same frequency layer as the apparatus, wherein the wide area cell is measured as a cell with a certain received signal level at a location of the apparatus; and a processor configured to set an allocation of channels for local area data transmission from the apparatus based on the conditions of the wide area cell such that interference of the channels for the local area data transmission with allocated wide area channels of the wide area cell is avoided.

2. The apparatus of claim 1, wherein the receiver comprises a user equipment configured to receive signals from the overlay wide area macro network and measure the wide area cell as the cell with the certain received signal level which is the highest signal level received by the user equipment from the overlay wide area macro network, and wherein the user equipment is configured to measure the conditions of the wide area cell.

3. The apparatus of claim 1, wherein the conditions of the wide area cell comprise wide area resources over which channels of the wide area cell are transmitted, wherein the processor is configured to prohibit use of the wide area resources for the allocation of channels for the local area data transmission from the apparatus.

4. The apparatus of claim 1, wherein the conditions of the wide area cell comprise wide area resources over which
channels of the wide area cell are transmitted, wherein the processor is configured to prioritize use of resources for the allocation of channels for the local area data transmission from the apparatus other than the wide area resources.

5. The apparatus of claim 4, wherein the processor is configured to reduce transmission power for the local area data transmission from the apparatus in case resources colliding with the wide area resources are used for the local area data transmission from the apparatus.

6. The apparatus according to claim 3, wherein the channels of the wide area cell comprise at least one of a physical downlink shared channel, a physical broadcast channel and a physical synchronization channel.

7. The apparatus according to claim 1, wherein the conditions of the wide area cell comprise timing information on a transmission time of channels of the wide area cell, wherein the processor is configured to set a time shift of the allocation of channels for the local area data transmission from the apparatus based on the timing information such that the allocation of channels for the local data transmission is different in timing from that of the channels of the wide area cell.

8. The apparatus of claim 7, wherein the processor is configured to communicate an identity of the wide area cell and the time shift set by the processor to a network element, and to alter the time shift based on a response from the network element.

9. The apparatus according to claim 7, wherein the processor is configured to set the time shift based on timing information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in timing from that of the channels of the wide area cell and the at least one of the further wide area cells and the cells for local area data transmission.

10. The apparatus according to claim 7, wherein the processor is configured to set the time shift based on timing information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in timing from that of the channels of the wide area cell and is different in timing from that of the at least one of the further wide area cells and the cells for local area data transmission with priority in order to the received signal levels of the at least one of the further wide area cells and the cells for local area data transmission.

11. The apparatus according to claim 7, wherein the channels for the local data transmission and the channels of the wide area cell comprise at least one of a physical broadcast channel, a synchronization channel, reference symbols and a physical downlink control channel.

12. The apparatus according to claim 1, wherein the conditions of the wide area cell comprise an identity of the wide area cell and frequency information on a transmission frequency of channels of the wide area cell, wherein the processor is configured to calculate a local area cell identity for achieving a frequency shift of the allocation of channels for the data transmission from the apparatus different from the identity of the wide area cell and based on the frequency information such that the allocation of channels for the local data transmission is different in frequency from that of the channels of the wide area cell.

13. The apparatus of claim 12, wherein the processor is configured to calculate the local area cell identity based on the time shift set by the processor.

14. The apparatus of claim 12, wherein the processor is configured to communicate the identity of the wide area cell and the local area cell identity calculated by the processor to a network element, and to alter the local area cell identity based on a response from the network element.

15. The apparatus of claim 13, wherein the processor is configured to communicate the identity of the wide area cell, the local area cell identity calculated by the processor and the time shift set by the processor to a network element, and to alter the local area cell identity based on a response from the network element.

16. The apparatus according to claim 12, wherein the processor is configured to calculate the local area cell identity based on an identity and frequency information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in frequency from that of the channels of the wide area cell and the at least one of the further wide area cells and the cells for local area data transmission.

17. The apparatus according to claim 12, wherein the processor is configured to calculate the local area cell identity based on an identity and frequency information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in frequency from that of the channels of the wide area cell and is different in timing from that of the at least one of the further wide area cells and the cells for local area data transmission with priority in order to the received signal levels of the at least one of the further wide area cells and the cells for local area data transmission.

18. The apparatus according to claim 16, wherein the processor is configured to calculate the local area cell identity further based on the time shift set by the processor.

19. The apparatus of claim 12, wherein the channels for the local data transmission and the channels of the wide area cell comprise at least one of a physical control format indicator channel, a physical hybrid ARQ indicator channel and reference symbols.

20. The apparatus of claim 1, wherein the receiver is configured to obtain measurements from a plurality of user equipments receiving signals from the overlay wide area macro network, each user equipment of the plurality of user equipments measuring a particular wide area cell as a cell with the highest signal level received by the user equipment from the overlay wide area macro network, and measuring the conditions of the particular wide area cell, wherein the receiver is configured to select the cell with the highest overall received signal level from the particular wide area cells as the wide area cell.

21. The apparatus of claim 17, wherein the receiver is configured to select at least one further cell from the particular wide area cells with priority in order to their received signal levels, wherein the processor is configured to set the allocation of channels for the local area data transmission from the apparatus based on the conditions of the wide area cell and the at least one further cell such that interference of the channels for the local area data transmission with allocated wide area channels of the wide area cell and the at least one further cell is avoided.

22. A method, comprising: obtaining conditions of a wide area cell of an overlay wide area macro network operated on the same frequency layer as an apparatus for local data transmission, wherein the wide area cell is measured as a cell with a certain received signal level at a location of the apparatus; and setting an allocation of channels for the local area data transmission from the apparatus based on the conditions of the wide area cell such that interference of the channels for the local area data transmission with allocated wide area channels of the wide area cell is avoided.

23. The method of claim 22, wherein the obtaining comprises: receiving signals from the overlay wide area macro network and measuring the wide area cell as the cell with the certain received signal level which is the highest signal level received from the overlay wide area macro network; and measuring the conditions of the wide area cell.

24. The method of claim 22, wherein the conditions of the wide area cell comprise wide area resources over which channels of the wide area cell are transmitted, the method comprising: prohibiting use of the wide area resources for the allocation of channels for the local area data transmission from the apparatus.

25. The method of claim 22, wherein the conditions of the wide area cell comprise wide area resources over which channels of the wide area cell are transmitted, the method comprising: prioritizing use of resources for the allocation of channels for the local area data transmission from the apparatus other than the wide area resources.

26. The method of claim 25, comprising: reducing transmission power for the local area data transmission from the apparatus in case resources colliding with the wide area resources are used for the local area data transmission from the apparatus.

27. The method according to claim 24, wherein the channels of the wide area cell comprise at least one of a physical downlink shared channel, a physical broadcast channel and a physical synchronization channel.

28. The method according to claim 22, wherein the conditions of the wide area cell comprise timing information on a transmission time of channels of the wide area cell, the method comprising: setting a time shift of the allocation of channels for the local area data transmission from the apparatus based on the timing information such that the allocation of channels for the local data transmission is different in timing from that of the channels of the wide area cell.

29. The method of claim 28, comprising: communicating an identity of the wide area cell and the time shift set to a network element, and altering the time shift based on a response from the network element.

30. The method according to claim 28, the setting comprising: setting the time shift based on timing information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in timing from that of the channels of the wide area cell and the at least one of the further wide area cells and the cells for local area data transmission.

31. The method according to claim 28, the setting comprising: setting the time shift based on timing information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in timing from that of the channels of the wide area cell and is different in timing from that of the at least one of the further wide area cells and the cells for local area data transmission with priority in order to the received signal levels of the at least one of the further wide area cells and the cells for local area data transmission.

32. The method according to claim 28, wherein the channels for the local data transmission and the channels of the wide area cell comprise at least one of a physical broadcast channel, a synchronization channel, reference symbols and a physical downlink control channel.

33. The method according to claim 22, wherein the conditions of the wide area cell comprise an identity of the wide area cell and frequency information on a transmission frequency of channels of the wide area cell, the method comprising: calculating a local area cell identity for achieving a frequency shift of the allocation of channels for the data transmission from the apparatus different from the identity of the wide area cell and based on the frequency information such that the allocation of channels for the local data transmission is different in frequency from that of the channels of the wide area cell.

34. The method of claim 33, the selecting comprising: calculating the local area cell identity based on the time shift set.

35. The method of claim 33, comprising: communicating the identity of the wide area cell and the local area cell identity calculated to a network element, and altering the local area cell identity based on a response from the network element.

36. The method of claim 34, comprising: communicating the identity of the wide area cell, the local area cell identity calculated and the time shift set to a network element, and altering the local area cell identity based on a response from the network element.

37. The method according to claim 33, the calculating comprising: calculating the local area cell identity based on an identity and frequency information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in frequency from that of the channels of the wide area cell and the at least one of the further wide area cells and the cells for local area data transmission.

38. The method according to claim 33, the calculating comprising: calculating the local area cell identity based on an identity and frequency information measured from at least one of further wide area cells of the overlay wide area macro network with the certain received signal level at the location of the apparatus and cells for local area data transmission with the certain received signal level at the location of the apparatus such that the allocation of channels for the local data transmission from the apparatus is different in frequency from that of the channels of the wide area cell and is different in timing from that of the at least one of the further wide area cells and the cells for local area data transmission with priority in order to the received signal levels of the at least one of the further wide area cells and the cells for local area data transmission.

39. The method according to claim 37, the calculating comprising calculating the local area cell identity further based on the time shift set.

40. The method of claim 33, wherein the channels for the local data transmission and the channels of the wide area cell comprise at least one of a physical control format indicator channel, a physical hybrid ARQ indicator channel and reference symbols.

41. The method of claim 22, the obtaining comprising: obtaining measurements from a plurality of user equipments receiving signals from the overlay wide area macro network, each user equipment of the plurality of user equipments measuring a particular wide area cell as a cell with the highest signal level received by the user equipment from the overlay wide area macro network, and measuring the conditions of the particular wide area cell; and selecting the cell with the highest overall received signal level from the particular wide area cells as the wide area cell.

42. The method of claim 41, comprising: selecting at least one further cell from the particular wide area cells with priority in order to their received signal levels, the setting comprising: setting the allocation of channels for the local area data transmission from the apparatus based on the conditions of the wide area cell and the at least one further cell such that interference of the channels for the local area data transmission with allocated wide area channels of the wide area cell and the at least one further cell is avoided.

43. A computer program product including a program for a processing device, comprising software code portions for performing the method of claim 22 when the program is run on the processing device.

44. The computer program product according to claim 43, wherein the computer program product comprises a computer-readable medium on which the software code portions are stored.

45. The computer program product according to claim 43, wherein the program is directly loadable into an internal memory of the processing device.

46. An apparatus, comprising: receiving means for obtaining conditions of a wide area cell of an overlay wide area macro network operated on the same frequency layer as the apparatus, wherein the wide area cell is measured as a cell with a certain received signal level at a location of the apparatus; and processing means for setting an allocation of channels for local area data transmission from the apparatus based on the conditions of the wide area cell such that interference of the channels for the local area data transmission with allocated wide area channels of the wide area cell is avoided.
